(19) United States
(12) Patent Application Publication
(10) Pub. No.: US 2009/0109912 A1
(43) Pub. Date: Apr. 30, 2009

(54) METHOD AND APPARATUS FOR PRE-ALLOCATION OF UPLINK CHANNEL RESOURCES

(75) Inventors: Rocco DiGirolamo, Laval (CA); Christopher R. Cave, Montreal (CA); Diana Pani, Montreal (CA); Paul Marinier, Brossard (CA)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: INTERDIGITAL PATENT HOLDINGS, INC., Wilmington, DE (US)

(21) Appl. No.: 12/256,916

(22) Filed: Oct. 23, 2008

Related U.S. Application Data
(60) Provisional application No. 60/982,629, filed on Oct. 25, 2007.
(60) Provisional application No. 61/018,924, filed on Jan. 4, 2008.

(51) Int. Cl. H04W 72/04

(52) U.S. Cl. 370/329

(57) ABSTRACT

A method and apparatus for pre-allocating uplink resources in CELL-FACH are disclosed. A wireless transmit/receive unit (WTRU) in CELL_FACH or CELL_PCH states may be pre-allocated with an uplink resource when a downlink transmission is transmitted. The WTRU may then use the pre-allocated uplink resource for channel quality information or hybrid automatic repeat request (HARQ) feedback, or any other purposes. The pre-allocated uplink resource may be enhanced dedicated channel (E-DCH) resource or high speed dedicated physical control channel (HS-DPCCH) resource.

### CROSS REFERENCE TO RELATED APPLICATIONS

This application claims the benefit of U.S. provisional application Nos. 60/982,629 filed Oct. 25, 2007 and 61/018,924 filed Jan. 4, 2008, which are incorporated by reference as if fully set forth.

### FIELD OF INVENTION

This application is related to wireless communications.

### BACKGROUND

Enhanced uplink has been introduced as part of the release 6 of the third generation partnership project (3GPP) standards. The enhanced uplink operates on a rate request and grant mechanism. A wireless transmit/receive unit (WTRU) sends a rate request indicating the requested capacity, while a network responds with a rate grant to the rate request. The rate grant is generated by a Node B scheduler. The WTRU and a Node B use a hybrid automatic repeat request (HARQ) mechanism for transmissions over an enhanced dedicated channel (E-DCH).

For enhanced uplink transmission, two uplink physical channels (E-DCH dedicated physical control channel (E-DPCCH) and an E-DCH dedicated physical data channel (E-DPDCH)) and three downlink physical channels (E-DCH absolute grant channel (E-AGCH), E-DCH relative grant channel (E-RGCH), and E-DCH HARQ indicator channel (E-HICH)) have been introduced. The Node B may issue both absolute grants and relative grants. Rate grants are signaled in terms of a power ratio. Each WTRU maintains a serving grant that can be converted to a payload size.

WTRUs that make E-DCH transmissions have an E-DCH active set. The E-DCH active set includes all cells for which the WTRU has an established E-DCH radio link. The E-DCH active set is a subset of a dedicated channel (DCH) active set. A distinction is made between those radio links that are part of the E-DCH radio link set (RLS) and those that are not. The former includes radio links that share the same Node B as a serving Node B. Cells for non-serving radio links may only send relative grants in an effort to limit or control the uplink interference.

As part of ongoing evolution of the wideband code division multiple access (WCDMA) standard in 3GPP release 8, a new work item has been established to incorporate E-DCH concepts for WTRUs in a CELL_FACH state. In Release 7 and earlier, the only uplink mechanism for WTRUs in a CELL_FACH state was a random access channel (RACH). The RACH is based on a slotted-Aloha mechanism with an acquisition indication. Before sending a message on an RACH, a WTRU tries to acquire the channel by sending a short preamble (made up of a randomly selected signature sequence) in a randomly selected access slot. The WTRU then listens and waits for an acquisition indication from the universal terrestrial radio access network (UTRAN). If no indication is received, the WTRU ramps up its power and tries again (sending a randomly selected signature sequence in a selected access slot). If an acquisition indication is received, the WTRU has effectively acquired the channel, and may transmit an RACH message part. The initial preamble transmit power is established based on an open loop power control, whereas the ramp-up mechanism is used to further fine-tune the transmit power. The RACH message is transmitted at a fixed power offset from the last preamble and is of fixed size. Macro-diversity is not employed and the WTRU has no concept of active set for the RACH.

The new work item attempts to increase the uplink user plane and control plane throughput by assigning dedicated E-DCH resources after the initial WTRU power ramp up, (it is referred to “enhanced Uplink in CELL_FACH state and Idle Mode” or “enhanced RACH”). FIG. 1 shows an enhanced RACH operation. A WTRU transmits a RACH preamble in order to acquire a channel implementing power ramp-up. Once the RACH preamble is detected, a Node B transmits an acquisition indication (AI). After receiving the AI, the WTRU is assigned with an E-DCH resource for a subsequent E-RACH message transmission. The E-DCH resource assignment may be made either with the AI or with an enhanced set of AIs. The WTRU then transmits an E-RACH message and enters a contention resolution phase. The contention resolution phase is provided to solve potential collision of the E-RACH message. After transmission of all E-RACH messages, explicit indication from UTRAN, radio link failure, post verification failure, or expiry of a timer, the E-DCH resource is released.

A WTRU in a CELL_FACH state may use high speed downlink packet access (HSDPA) in the downlink and would benefit from uplink feedback for both channel quality and HARQ feedback. It has been suggested that during the initial resource assignment, the WTRU be configured with a dedicated uplink feedback channel, (i.e., high speed dedicated physical control channel (HS-DPCCH)), as is the case for CELL_DCH WTRUs.

However, it has several problems. First, the initial transmissions on the high speed downlink channel may not be privy to channel quality information. In 3GPP Release 7, this was partially addressed by having the Node B use the channel quality information carried in an information element (IE), “Measured Results on RACH”. This IE is included in a number of layer 3 radio resource control (RRC) messages. In addition, a WTRU in a CELL_PCH state receiving dedicated control or data traffic is triggered to send channel quality information through a layer 3 measurement report upon reception of high speed downlink control traffic, (i.e., high speed shared control channel (HS-SCCH) with the WTRU address). However, as the feedback is sent through RRC signaling, it may be too slow for efficient modulation and coding control of the initial high speed downlink transmission.

Second, the 3GPP Release 7 approach is geared more toward WTRU-initiated control traffic, (for instance a CELL UPDATE). In a typical scenario, the WTRU would tag along channel quality information to the uplink RRC message. The network would then use this information to determine the allowed modulation and transport block size, and then send an RRC network response using the selected parameters. However, there may be some inefficiency if the uplink traffic is user-plane data traffic and does not carry any channel quality information, or is an RRC message that does not carry the IE: “Measured Results on RACH”, or if user-plane and control-plane traffic is network-initiated.

In both cases, the network may not have timely channel quality information and it would have to rely on the information received in the last IE: “Measured Results on RACH”. This inefficiency is likely to be more prevalent with enhanced RACH, as the network may decide to keep more WTRUs in a CELL_FACH state, for example to deal with asymmetric type applications, such as web browsing. It is likely that these WTRUs are kept in a CELL_FACH state, but that their enhanced RACH resources are released (for instance, after the WTRU has finished its transmission). As a result, any subsequent network-initiated downlink transmissions will not have “up-to-date” channel quality information. This would result in some inefficiency as the network would not be able to maximize the downlink transmission rate.

### SUMMARY

A method and apparatus for pre-allocating uplink resources in CELL-FACH are disclosed. A WTRU in CELL_FACH or CELL_PCH states may be pre-allocated with an uplink resource when a downlink transmission is transmitted. The WTRU may then use the pre-allocated uplink resource for channel quality information or HARQ feedback, or any other purposes. The pre-allocated uplink resource may be E-DCH resource or HS-DPCCH resource.

### BRIEF DESCRIPTION OF THE DRAWINGS

A more detailed understanding may be had from the following description, given by way of example in conjunction with the accompanying drawings wherein:

FIG. 1 shows an enhanced-RACH operation;

FIGS. 2(A) and 2(B) show example MAC-e PDU formats including a CQI field;

FIG. 2(C) shows an example MAC-i header including a CQI field;

FIG. 3 shows an example MAC-es PDU format including a CQI field; and

FIG. 4 is a block diagram of an example WTRU.

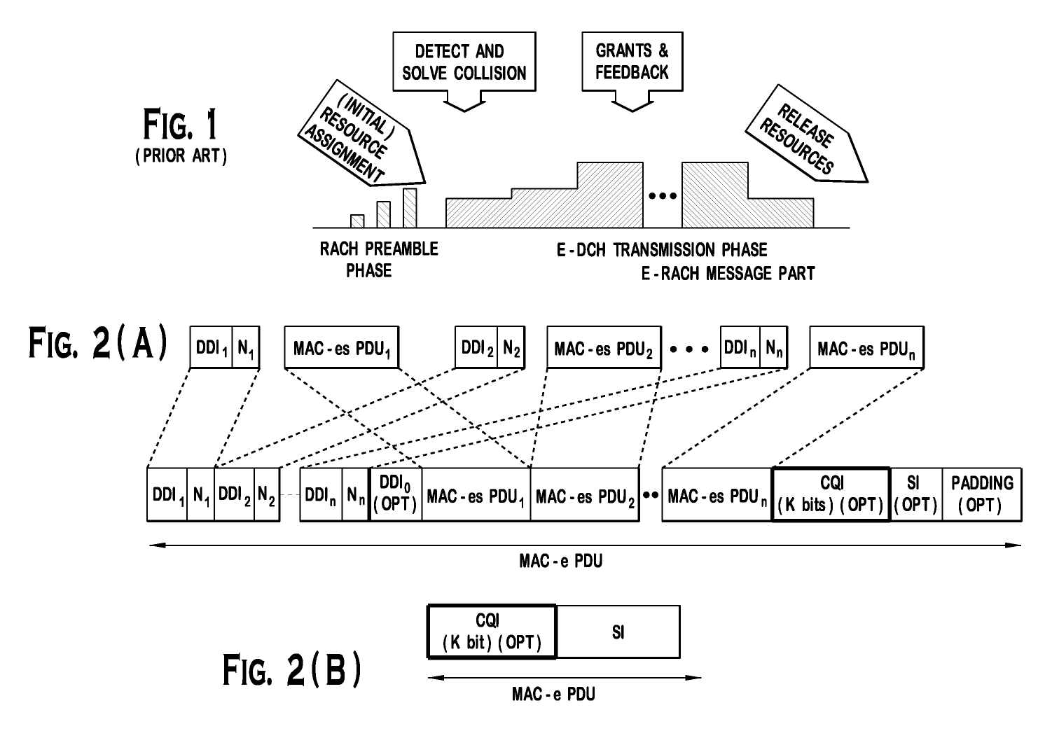

### DETAILED DESCRIPTION

When referred to hereafter, the terminology “WTRU” includes but is not limited to a user equipment (UE), a mobile station, a fixed or mobile subscriber unit, a pager, a cellular telephone, a personal digital assistant (PDA), a computer, or any other type of user device capable of operating in a wireless environment. When referred to hereafter, the terminology “Node B” includes but is not limited to a base station, a site controller, an access point (AP), or any other type of interfacing device capable of operating in a wireless environment. When referred to hereafter, the terminology “Enhanced RACH” refers to the use of enhanced uplink (E-DCH) in CELL_FACH state and in an idle mode. The Enhanced RACH transmission may use Release 6 MAC-e/es entities or MAC-i/is entities that are introduced in Release 8 as part of the “Improved Layer 2” feature. The terminologies “MAC-e/es PDU” and “MAC-i/is PDU” include, but are not limited to, the PDUs generated by the MAC-e/es entities, PDUs generated by the MAC-i/is entities, or any PDUs generated by the MAC entity used to perform E-DCH transmission in the CELL_FACH state and an idle mode. When referred to hereafter, the reception of an acquisition indication refers to the allocation of an E-DCH resource to the WTRU via a positive acknowledgement (ACK) on an acquisition indication channel (AICH) or via a negative acknowledgement (NACK) on the AICH followed by an index over an enhanced AICH (E-AICH). When referred to hereafter, the HS-DPCCH information refers to the information required by a WTRU in order to send HS-DPCCH feedback, such as the delta ACK/NACK, delta CQI, CQI feedback cycle, etc. When referred to hereafter, the terminology “HS-DPCCH resource” refers to the uplink/downlink channels required for support of HS-DPCCH transmission, the uplink scrambling code information, the HS-DPCCH information, etc.

In accordance with a first embodiment, channel quality information is transmitted along with an initial uplink transmission, (e.g., E-DCH message), after a WTRU has been assigned an enhanced RACH resource. For random access, the WTRU transmits a random access preamble. After detecting the preamble, a Node B transmits an acquisition indication, and selects an E-DCH resource from the common pool of resources and assigns the selected E-DCH resource to the WTRU. The WTRU then transmits E-DCH message using the allocated E-DCH resource along with the channel quality information.

The transmission of the channel quality information may be triggered upon receipt of an acquisition indication after successful random access ramp-up procedure, or when the WTRU receives a downlink transmission after having received a resource allocation through an acquisition indication. The WTRU may detect the downlink transmission when it receives an HS-SCCH transmission with its address. Additionally, the WTRU may also trigger transmission of the channel quality information when the WTRU has uplink data to transmit in CELL_FACH, CELL_PCH, or URA_PCH.

In response to this trigger the WTRU prepares the channel quality information and sends it with the initial uplink transmission. This transmission may include WTRU identity (ID) to help detection of enhanced RACH message collision, and/or initial scheduling information to allow proper rate grant generation for the allocated E-DCH resources. The channel quality information may be encoded and transmitted as a K-bit channel quality indicator (CQI).

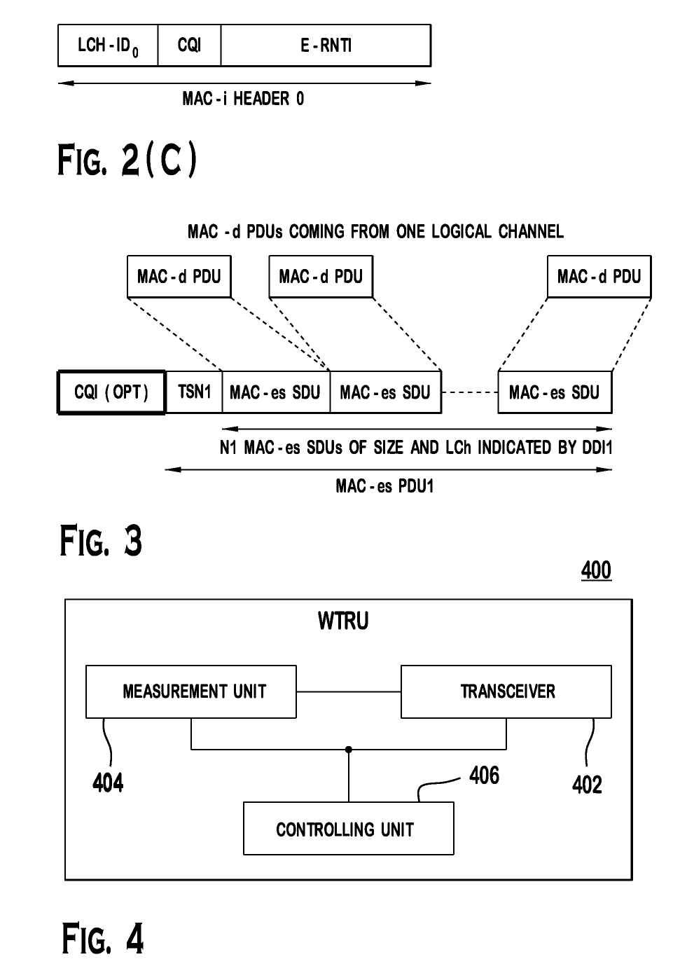

The channel quality information may be transmitted through a modified header or trailer of an MAC-e or MAC-i PDU. FIGS. 2(A) and 2(B) show example MAC-e PDU formats including a CQI field, and FIG. 2(C) shows an example MAC-i header including a CQI field. An MAC-e PDU includes a header, one or more MAC-es PDUs, and an optional trailer. A CQI may be included in a trailer of the MAC-e PDU that carries data, as shown in FIG. 2(A). A CQI may be transmitted only with scheduling information (SI), as shown in FIG. 2(B).

An indication may be included in the MAC-e or MAC-i PDU to tell the Node B whether the MAC-e or MAC-i PDU includes the optional CQI field. Alternatively, the CQI field may always be appended to the MAC-e or MAC-i PDU for every uplink transmission in CELL_FACH so that the network would not require an indication for the presence of the CQI field. Alternatively, the CQI may be present only in the MAC-e or MAC-i PDU sent during the collision resolution phase. The network would then implicitly know that the MAC-e or MAC-i PDU received contains a CQI report for the initial transmissions.

The MAC-i header in FIG. 2(C) carries a WTRU identity, (e.g., E-RNTI), and is identified at the UTRAN via a special reserved logical channel identity. The MAC-i header 0 is used for E-RACH contention resolution and, prior to contention resolution, is included in all MAC-i PDUs. The CQI may be transmitted in place of the spare bits, which were introduced to guarantee octet alignment. The reserved logical channel identity may be used after contention resolution to indicate the transmission of a stand alone CQI (with no WTRU identity). Alternatively, a new logical channel may be reserved to indicate the transmission of a stand-alone CQI.

Alternatively, the CQI may be carried in the header of the MAC-es or MAC-is PDU. FIG. 3 shows an example MAC-es PDU format including a CQI field. One or more MAC-es SDUs, (i.e., MAC-d PDUs), are included in an MAC-es PDU, and the MAC-es PDU includes a transmission sequence number (TSN) field as an MAC-es header. As shown in FIG. 3, the CQI field may be included in the MAC-es header.

As the MAC-es terminates at the radio network controller (RNC), the CQI information would have to be forwarded from the RNC to the Node B through the Iub frame protocol.

Alternatively, the CQI may be provided through RRC signaling from the WTRU to the UTRAN, similar to the conventional mechanism using “Measured Results on RACH” IE. However, transmitting the CQI provides a better estimate of channel quality than the conventional measurement reporting through the Measured Results on RACH IE including common pilot channel (CPICH) received signal code power (RSCP) or Ec/No.

Alternatively, the uplink transmission may be used as a trigger to send the CQI over the HS-DPCCH. For uplink transmission, the WTRU makes a request for an E-DCH resource. A list of available E-DCH resources is broadcast in a system information block (SIB) and an index to the list may be given to the WTRU for E-DCH resource assignment, and the assigned E-DCH resource may have a one-to-one mapping to the HS-DPCCH information required for the WTRU to transmit a CQI and optionally ACK/NACK feedback via the HS-DPCCH. Alternatively, the network may assign an index to the list that contains the E-DCH resources and the HS-DPCCH information may also be listed as part of the information. In both cases, the HS-DPCCH may also be used to provide HARQ ACK/NACK feedback for information received on the HS-DSCH.

In accordance with a second embodiment, when a network initiates a downlink transmission to a WTRU in CELL_FACH that has no E-DCH resource, the WTRU may use this downlink transmission as a trigger to send channel quality information. For example, this may occur after initial RRC connection has been established, or after the E-DCH resource has been released for some reason. The WTRU in a CELL_FACH state may use the downlink transmission as a trigger to start an uplink access in order to send fresh channel quality information and/or HARQ feedback for the downlink transmission.

In order to provide feedback, the WTRU may request an E-DCH resource or an HS-DPCCH resource. The request may be done via the enhanced uplink random access procedure, where the WTRU waits for an AICH or an E-AICH to get an E-DCH resource. Where the WTRU requests an E-DCH resource, the WTRU is assigned configuration information for all channels associated with E-DCH transmission, (i.e., dedicated physical control channel (DPCCH), fractional dedicated physical channel (F-DPCH), E-AGCH, E-RGCH, E-HICH, E-DPCCH, and/or E-DPDCH). With the assigned E-DCH resource, the WTRU may send a CQI in the MAC-i/is or MAC-e/es header. Alternatively, HS-DPCCH information may be associated with the assigned E-DCH resource and the WTRU may send a CQI and optionally HARQ ACK/NACK feedback over the associated HS_DPCCH.

In case that the WTRU requests an HS-DPCCH resource, the WTRU receives the necessary channels to allow HS-DPCCH transmission, including the uplink and downlink control channels for power control, (such as the F-DPCH and the DPCCH, and the required HS-DPCCH information), but excluding one or more of the other E-DCH channels. The HS-DPCCH resource may be part of a separate pool of resources assigned to the WTRU on a per need basis. For example, if the WTRU only needs to send feedback over an HS-DPCCH and has no other uplink traffic, there is no need for the network to waste E-DCH resources and block other WTRUs. Therefore, the network assigns the HS-DPCCH resource index from a separate pool of resources if the WTRU does not have uplink traffic. Both CQI and HARQ ACK/NACK feedback may be transmitted over the assigned HS-DPCCH.

The trigger to initiate uplink access to carry CQI information and/or ACK/NACK feedback may be the reception of a correctly decoded HS-SCCH (HS-SCCH transmission that is masked with the WTRU HS-DSCH radio network temporary identity (H-RNTI)) and/or reception of data on the associated high speed physical downlink shared channel (HS-PDSCH), or upon reception of a downlink forward access channel (FACH) transmission. Optionally, the triggering condition may also depend on whether the WTRU has been assigned with a dedicated (H-RNTI) and/or E-DCH radio network temporary identity (E-RNTI). In some cases, the WTRU may not have an E-RNTI and is not allowed to transmit dedicated traffic channel (DTCH)/dedicated control channel (DCCH) transmissions using the Enhanced RACH. In these cases, the WTRU may decide not to initiate an uplink transmission for CQI transmission. If the WTRU does not have an H-RNTI and E-RNTI allocated, the WTRU may not send HS-DPCCH feedback even if the WTRU has an allocated E-DCH resource and the required information.

In accordance with a third embodiment, if the WTRU has no E-DCH resources, the WTRU in a CELL_FACH state may be configured to periodically start a new uplink transmission in order to send fresh channel quality information. When the WTRU has no uplink data and has not received any downlink transmission, and therefore the triggering conditions of the first and second embodiments are not met, the WTRU may periodically start an uplink transmission for the purpose of sending a fresh CQI. The CQI may be transmitted using any method disclosed above. For example, the CQI may be included in MAC-e/es or MAC-i/is header/trailer, on HS-DPCCH associated with E-DCH, on HS-DPCCH without E-DCH transmission.

For the network initiated downlink transmission and feedback triggers, the network may pre-allocate E-DCH resources to the WTRU along with the initial downlink transmission. As the E-DCH resource is pre-assigned to a particular WTRU, there would be no possibility of collision on the E-DCH transmissions, and this would eliminate the need for a collision detection phase associated with the PRACH preamble procedure. The E-DCH resource pre-allocation may include configuration information for the DPCCH, F-DPCH, E-AGCH, E-RGCH, E-HICH, E-DPCCH, and/or E-DPDCH, and/or the HS-PDCCH information. The configuration information may be transmitted via an RRC signal sent over an FACH, an HS-DSCH, or an L2 signal sent in an appropriate MAC header. For instance, a reserved value of the LCH-ID can be used to indicate that an index is appended to MAC PDU. Alternatively, an L1 signal sent over the HS-SCCH (i.e., an HS-SCCH order, which optionally contains an index) can be used or alternatively a new L1 signal may be used. The L1 signal, the HS-SCCH or the new message may be an index into the list of E-DCH resources broadcasted over the SIB, whose entries specify the needed configuration parameters. The L1 signal may provide an index or alternatively it may just provide an indication that DL feedback is required. This may trigger the WTRU to initiate the random access procedure to request E-DCH resources in order to get the required parameters for HS-DPCCH transmission. Once the E-DCH configuration information is provided to the WTRU, the WTRU may establish the initial transmit power and start uplink transmission and/or uplink feedback.

Alternatively, for the network initiated downlink transmission, the network may pre-allocate an HS-DPCCH resource, which refers to the necessary channels to allow HS-DPCCH transmission, including the uplink and downlink control channels for power control, (such as the F-DPCH and the DPCCH), and the required HS-DPCCH information, but excluding one or more of the other E-DCH channels. The pre-allocation of the HS-DPCCH resource or of the full E-DCH resource provides the WTRU with a contention free access. The network may allocate only the HS-DPCCH resource or the full E-DCH resources, which contains the HS-DPCCH information. The HS-DPCCH, scrambling code and/or other E-DCH resources may be explicitly indicated by the network or it may be sent as an index to a group of resources broadcast over the SIBs. Optionally, the HS-DPCCH resource provided to the WTRU may be from a pool of broadcast resources to be used for contention free access or a pool of resources to be used for WTRUs that need to send only ACK/NACK and CQI feedback.

Alternatively for the network initiated downlink transmission, the network may pre-allocate an enhanced RACH preamble signature in the initial downlink transmission using one of the methods described above. The preamble signature may be from a reserved set of signatures that are under the control of the network and that are only used for pre-allocation or alternatively they may be the preamble signatures used for E-DCH UL random access procedure. The WTRU may use the enhanced RACH preamble signature to initiate an enhanced RACH preamble power ramp-up cycle to establish the right transmission power for the uplink transmission. Since the preamble signature has been pre-assigned to the WTRU, there is no possibility of collision. After the WTRU receives an indication of the assigned resource (E-DCH resource with or without HS-DPCCH or HS-DPCCH resource) through the AICH, the WTRU may immediately start transmission of the HS-DPCCH or other uplink data, if applicable, without having to perform a contention resolution phase.

The network may make the decision of whether or not to pre-allocate the E-DCH resources, HS-DPCCH resources, or RACH signature sequence based on the WTRU status. If a WTRU already has an E-DCH resource, the network may not pre-allocate any new E-DCH resources. On the other hand, if a WTRU does not have any E-DCH resources, the network may decide that it requires up-to-date channel quality information and so it pre-allocates an E-DCH resource, HS-DPCCH information, or RACH signature sequence to the WTRU. The reception of the pre-allocation may act as a trigger that the WTRU has to start sending feedback over the HS-DPCCH. If the WTRU does not have an E-DCH resource already active, and the WTRU receives downlink traffic, the WTRU may not send HS-DPCCH feedback unless otherwise indicated by the network via explicit signaling, as described above, or via the reception of a pre-allocated index as described above. Preferably, the network may not assign the same set of E-DCH resources to any other WTRU until the downlink transmission has been completed and the network does not expect any more ACK/NACK or CQI feedback or until a timer expires.

To counter the possibility that the pre-assigned resources could go unused, the network may start a timer when these resources are assigned. If there has been no WTRU activity on the pre-assigned resources until the timer expires, the resources may be released, via explicit signaling over the E-AGCH or via timers that are also active in the WTRU. After the resource is released, if necessary, the WTRU may make a preamble ramp-up procedure to subsequently acquire E-DCH resources.

Alternatively, the network may only pre-allocate E-DCH resources if the traffic that is carried on the downlink transmission requires a response, (for example, an RRC or RLC acknowledgement). If the network knows that the WTRU has to respond to the downlink transmission, (e.g., with an RLC ACK or with an RRC message), the network may pre-allocate an E-DCH resource to the WTRU since the WTRU will have to make a request for the uplink resource anyway. Once the WTRU has a pre-allocated resource, the WTRU may use the resource for CQI and/or HARQ ACK/NACK feedback. If the E-DCH resources for enhanced CELL_FACH are controlled by the Node B, the RNC may send an indication over the Iub frame protocol to notify the Node B about the type of traffic that is being transmitted on the downlink.

When the network pre-allocates resources, the WTRU needs to establish or determine the initial WTRU uplink dedicated physical control channel (DPCCH) transmission power. The WTRU may use the uplink enhanced RACH power ramp-up procedure to determine the initial power. More specifically, after the resources have been pre-allocated the WTRU uses the preamble signature corresponding to the received E-DCH index to initiate the transmission of the first preamble. The WTRU continues with the preamble phase until the WTRU receives an answer on the AICH. The WTRU then immediately starts the DPCCH transmission using a power offset from the last preamble power. Alternatively, the WTRU does not perform the ramp up procedure, but immediately initiates DPCCH transmission and then E-DCH transmission. The network may signal a DPCCH power offset, and the WTRU may determine the initial power based on this offset and a measured metric, (e.g., CPICH RSCP). Alternatively, the network may signal a fixed/absolute WTRU transmit power. Alternatively, the network may signal a DPCCH power offset to be used with respect to the uplink interference value broadcasted in SIB7, or with respect to the initial preamble power that would be used if the WTRU were to initiate an uplink enhanced random access procedure. The information for the initial transmit power may be broadcast as part of the system information or signaled in the E-DCH resource pre-allocation message. The WTRU may perform a synchronization procedure to allow the power control loop to synchronize. Alternatively, the WTRU in a CELL_FACH state may have a set of reserved signatures and/or access slots dedicated for this power control establishment and a unique combination may be included as part of the E-DCH resource pre-allocation message. This would eliminate the possibility of more than one WTRU selecting the same signature and/or access slot. If full E-DCH resources are allocated to the WTRU, the WTRU may be able to establish the transmit power and may not wait for an AICH to start transmitting the message, but rather begin on the pre-allocated resource as soon as the right power level is established. The right power level is established as described above. The WTRU starts DPCCH transmission based on one of the offset or on an absolute power and then starts E-DCH transmission and/or HS-DPCCH feedback. It is understood that in the case where the resources are pre-allocated the WTRU does not need to perform a collision resolution phase.

Conventionally, when a WTRU in a CELL_PCH state has uplink data to transmit or it detects its address (dedicated H-RNTI) in the HS-SCCH, the WTRU sends a layer 3 measurement report with either Ec/No or received signal code power (RSCP) value to update the network as to the channel quality information. In accordance with a fourth embodiment, a WTRU in a cell that supports E-DCH in CELL_FACH and CELL_PCH may not send the layer 3 measurement report when the WTRU in CELL_PCH decodes the dedicated H-RNTI in the HS-SCCH or the WTRU has uplink data to transmit in CELL_PCH, but may send a CQI using any of the techniques described above. For instance, the network may use one of the methods described above to pre-allocate a resource (E-DCH resource, HS-DPCCH resource, RACH preamble signature) and to trigger a state transition to CELL_FACH. The WTRU may use the pre-allocated resource to send CQI information. In addition, if the pre-allocated resource includes an HS-DPCCH, the WTRU may also send HARQ ACK/NACK feedback for the downlink transmissions. Alternatively, if the WTRU has uplink data to transmit, the WTRU may transition directly to CELL_FACH and begin an Enhanced Uplink in CELL_FACH access. The CQI may be transmitted in the assigned resource. The resource may be used for any required transmission (for example, a measurement report, scheduling information, uplink user-plane data, etc.). In both cases, the WTRU need not send the measurement report containing the “Measured Results on RACH” but instead send better channel quality information through one of the mechanisms stated above.

Alternatively, the WTRU may just perform a normal RACH access procedure in order to request an E-DCH resource to send feedback information.

For all the embodiments described above the WTRU may send the channel quality information more frequently for the initial phase. For example, if the WTRU has uplink transmission or decodes the H-RNTI in the HS-SCCH, the WTRU may send channel quality information at a more frequent rate, (i.e., consecutive transmit time intervals (TTIs) or N times faster than the configured rate for normal CQI reporting over HS-DPCCH). This will allow the network to optimally adjust the modulation and coding used for the subsequent downlink transmissions. Alternatively, the CQI may be sent periodically during the contention resolution phase (frequency of CQI reports may be configured to allow for the WTRU to send sufficient CQI reports during that phase), periodically for the duration of the RACH access, only if downlink traffic is being transmitted during the RACH access period of the WTRU, or a combination of the above.

FIG. 4 is a block diagram of an example WTRU 400. The WTRU 400 includes a transceiver 402, a measurement unit 404 (optional), and a controlling unit 406. The transceiver is configured to transmit and receive messages, such as transmit an RACH preamble and receive an AI in response to the RACH preamble. The measurement unit 404 is configured to measure a channel quality and generate channel quality information. The controlling unit 406 is configured to provide channel quality information in accordance with any one of the embodiments disclosed above via an E-DCH, HS-DPCCH, or the like, in CELL_FACH, CELL_PCH, or URA_PCH states.

Although features and elements are described above in particular combinations, each feature or element can be used alone without the other features and elements or in various combinations with or without other features and elements. The methods or flow charts provided herein may be implemented in a computer program, software, or firmware incorporated in a computer-readable storage medium for execution by a general purpose computer or a processor. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

A processor in association with software may be used to implement a radio frequency transceiver for use in a wireless transmit receive unit (WTRU), user equipment (UE), terminal, base station, radio network controller (RNC), or any host computer. The WTRU may be used in conjunction with modules, implemented in hardware and/or software, such as a camera, a video camera module, a videophone, a speakerphone, a vibration device, a speaker, a microphone, a television transceiver, a hands free headset, a keyboard, a Bluetooth® module, a frequency modulated (FM) radio unit, a liquid crystal display (LCD) display unit, an organic light-emitting diode (OLED) display unit, a digital music player, a media player, a video game player module, an Internet browser, and/or any wireless local area network (WLAN) or Ultra Wide Band (UWB) module.

What is claimed is:

1. A method for pre-allocating a resource for uplink transmission, the method comprising:
a wireless transmit/receive unit (WTRU) receiving a high speed downlink channel (HS-DSCH) transmission while in one of a CELL_FACH and CELL_PCH state;
the WTRU receiving a downlink message including a pre-allocated index to an uplink resource; and
the WTRU transmitting uplink transmission and uplink feedback information using the pre-allocated uplink resource.

2. The method of claim 1 wherein the uplink resource is one of an enhanced dedicated channel (E-DCH) resource, a high speed dedicated physical control channel (HS-DPCCH) resource, and a reserved random access channel (RACH) preamble signature.

3. The method of claim 2 wherein the E-DCH resource contains HS-DPCCH resource information.

4. The method of claim 1 wherein the uplink transmission and the uplink feedback information are transmitted without performing a collision resolution phase.

5. The method of claim 1 wherein the downlink transmission containing the pre-allocated index is sent using a high speed shared control channel (HS-SCCH) order.

6. The method of claim 2 wherein the E-DCH resource is allocated only if the WTRU has uplink data to transmit.

7. The method of claim 2 wherein the HS-DPCCH resource is part of a resource pool separate from E-DCH resource pool.

8. The method of claim 1 wherein the WTRU transmits at least one of channel quality indicator (CQI) and hybrid automatic repeat request (HARQ) feedback on the uplink feedback information.

9. The method of claim 8 wherein the CQI is included in one of MAC-e header, MAC-es header, MAC-i header, and MAC-is header.

10. The method of claim 8 wherein the CQI is included in a MAC-i header 0 that is transmitted for contention resolution.

11. The method of claim 1 wherein the uplink resource is allocated by sending the index to a group of resources broadcast over a system information block (SIB).

12. The method of claim 1 wherein the uplink resource is allocated if the downlink transmission requires a WTRU response.

13. The method of claim 1 wherein the uplink resource is allocated if downlink transmission requires up-to-date channel quality information.

14. The method of claim 1 wherein the uplink resource is released and returned to a common pool of resources if unused until expiration of a timer.

15. The method of claim 1 wherein the WTRU performs a random access channel (RACH) power ramp-up procedure to set a proper uplink transmit power level for the uplink transmission.

16. The method of claim 15 wherein the WTRU receives a RACH preamble signature and/or an access slot reserved for power control establishment and uses the reserved RACH preamble and/or access slot for the RACH power ramp-up procedure.

17. The method of claim 1 wherein the WTRU initiates dedicated physical control channel (DPCCH) transmission and transmits the uplink transmission without performing a random access channel (RACH) power ramp-up procedure.

18. The method of claim 17 wherein a transmit power of the DPCCH is determined based on one of DPCCH power offset and a measured metric, DPCCH power offset and broadcast uplink interference, DPCCH power offset and initial RACH preamble power.

19. The method of claim 17 wherein a transmit power of the DPCCH is set to a fixed transmit power determined and broadcasted by a network.

20. The method of claim 1 wherein the WTRU performs a synchronization procedure to allow a power control loop to synchronize for the uplink transmission.

21. A method for providing channel quality information, the method comprising:
a wireless transmit/receive unit (WTRU) in a CELL_PCH state receiving a downlink transmission; and
the WTRU transmitting a channel quality indicator (CQI) in response to the downlink transmission.

22. The method of claim 21 wherein the downlink transmission includes a pre-allocated uplink resource.

23. The method of claim 21 further comprising:
the WTRU sending hybrid automatic repeat request (HARQ) feedback in response to the downlink transmission.

24. A wireless transmit/receive unit (WTRU) for pre-allocating a resource for uplink transmission, the WTRU comprising:
a transceiver configured to receive a downlink transmission and transmit an uplink transmission and uplink feedback information while in one of CELL_FACH and CELL_PCH states, the downlink transmission including a pre-allocated index to an uplink resource; and
a controlling unit configured to control the uplink transmission and the uplink feedback information transmission using the pre-allocated uplink resource.

25. The WTRU of claim 24 wherein the uplink resource is at least one of an enhanced dedicated channel (E-DCH) resource, a high speed dedicated physical channel (HS-DPCCH) resource, and a reserved random access channel (RACH) preamble signature.

26. The WTRU of claim 25 wherein the E-DCH resource contains HS-DPCCH resource information.

27. The WTRU of claim 24 wherein the uplink transmission and the uplink feedback information are transmitted without performing a collision resolution phase.

28. The WTRU of claim 24 wherein the downlink transmission containing the pre-allocated index is sent using a high speed shared control channel (HS-SCCH) order.

29. The WTRU of claim 25 wherein the E-DCH resource is allocated only if the WTRU has uplink data to transmit.

30. The WTRU of claim 25 wherein the HS-DPCCH resource is part of a resource pool separate from E-DCH resource pool.

31. The WTRU of claim 24 wherein the WTRU transmits at least one of a channel quality indicator (CQI) and hybrid automatic repeat request (HARQ) feedback on the uplink feedback information.

32. The WTRU of claim 31 wherein the CQI is included in one of a MAC-e header, a MAC-es header, a MAC-i header, and a MAC-is header.

33. The WTRU of claim 31 wherein the CQI is included in a MAC-i header 0 that is transmitted for contention resolution.

34. The WTRU of claim 24 wherein the uplink resource is allocated by sending the index to a group of resources broadcast over a system information block (SIB).

35. The WTRU of claim 24 wherein the uplink resource is allocated if the downlink transmission requires a WTRU response.

36. The WTRU of claim 24 wherein the uplink resource is allocated if downlink transmission requires up-to-date channel quality information.

37. The WTRU of claim 24 wherein the uplink resource is released and returned to a common pool of resources if unused until expiration of a timer.

38. The WTRU of claim 24 wherein the controlling unit performs a random access channel (RACH) power ramp-up procedure to set a proper uplink transmit power level for the uplink transmission.

39. The WTRU of claim 24 wherein the controlling unit receives a RACH preamble signature and/or an access slot reserved for power control establishment and uses the reserved RACH preamble and/or access slot for the RACH power ramp-up procedure.

40. The WTRU of claim 24 wherein the controlling unit initiates dedicated physical control channel (DPCCH) transmission and transmits the uplink transmission without performing a random access channel (RACH) power ramp-up procedure.

41. The WTRU of claim 40 wherein a transmit power of the DPCCH is determined based on one of DPCCH power offset and a measured metric, DPCCH power offset and broadcast uplink interference, DPCCH power offset and initial RACH preamble power.

42. The WTRU of claim 40 wherein a transmit power of the DPCCH is set to a fixed transmit power determined and broadcasted by a network.

43. The WTRU of claim 24 wherein the WTRU performs a synchronization procedure to allow a power control loop to synchronize for the uplink transmission.

44. A wireless transmit/receive unit (WTRU) configured to provide channel quality information, the WTRU comprising:
a transceiver configured to receive a downlink transmission while in a CELL_PCH state; and
a controlling unit configured to transmit a channel quality indicator (CQI) in response to the downlink transmission.

45. The WTRU of claim 44 wherein the downlink transmission includes a pre-allocated uplink resource.

46. The WTRU of claim 44 wherein the controlling unit is configured to send hybrid automatic repeat request (HARQ) feedback in response to the downlink transmission.
